(19) United States
(12) Patent Application Publication
(10) Pub. No.: US 2025/0332699 A1
(43) Pub. Date: Oct. 30, 2025

(54) PLIER APPARATUS

(71) Applicant: Greg Schneider, Mesa, AZ (US)

(72) Inventor: Greg Schneider, Mesa, AZ (US)

(21) Appl. No.: 19/188,979

(22) Filed: Apr. 24, 2025

Related U.S. Application Data
(60) Provisional application No. 63/637,916, filed on Apr. 24, 2024.

(51) Int. Cl. B25B 27/10

(52) U.S. Cl. CPC B25B 27/10

(57) ABSTRACT

A plier apparatus for facilitating the insertion of drip couplings into tubing or pipe comprises first and second elongated bodies pivotally connected at a fulcrum point. The first elongated body integrates a tube grip configured to securely hold tubing ranging from 0.125 to 2 inches in diameter, while the second elongated body features a holder sized to accommodate drip couplings from 0.25 to 0.75 inches. This configuration enables simultaneous manipulation of both components through a single actuation motion. The apparatus incorporates a force-multiplying mechanism using opposing cams that reduces required hand strength by at least 50%. The plier apparatus can include ergonomic handles with anti-slip materials; a ratcheting mechanism allowing incremental advancement; interchangeable holder inserts accommodating multiple coupling sizes; a coupling alignment indicator system; and a depth control mechanism preventing over-insertion.

### CROSS REFERENCE TO RELATED APPLICATIONS

This application claims benefit from currently pending U.S. Provisional Application No. 63/637,916 titled “Plier Apparatus” and having a filing date of May 24, 2024, all of which is incorporated by reference herein.

### FIELD OF THE INVENTION

The present invention pertains broadly to the field of plumbing and irrigation tools, and more specifically to a plier apparatus designed for facilitating the insertion of a drip coupling into various types of tubing or pipe.

### BACKGROUND OF THE INVENTION

Drip irrigation systems have become increasingly popular in agricultural, landscaping, and gardening applications due to their water efficiency and effectiveness in delivering water directly to plant root zones. These systems typically consist of a network of tubes or pipes connected by various fittings, including drip couplings that allow for the precise delivery of water to desired locations. One of the most challenging aspects of installing or maintaining a drip irrigation system is the insertion of drip couplings into flexible tubing or rigid pipe. The conventional method of inserting a ¼″ drip coupling into tubing involves manually forcing the coupling into the tubing by hand, which presents several difficulties and drawbacks.

When attempting to insert a drip coupling by hand, users often encounter significant resistance due to the tight fit required to prevent leakage. This resistance makes the insertion process physically demanding and potentially painful, especially when installing multiple couplings during a large irrigation system setup. Additionally, the force required can lead to misalignment, resulting in damaged couplings, punctured tubing, or improper connections that may leak or fail over time. Various general-purpose tools such as standard pliers, vice grips, or channel locks have been employed to assist with this task. However, these tools are not specifically designed for the unique requirements of drip coupling insertion. When using standard pliers, users must awkwardly grip both the tubing and attempt to push the coupling simultaneously, often resulting in slippage, misalignment, or damage to the components.

Some installers resort to using lubricants to ease insertion, but this introduces additional complications, including potential contamination of the water supply, degradation of the tubing material over time, or reduced sealing effectiveness of the connection. Specialized insertion tools available in the market tend to be limited to specific sizes or types of fittings and lack versatility across different tubing materials or coupling sizes. Furthermore, many existing tools do not provide adequate grip on the tubing while simultaneously controlling the coupling insertion process. Manual procedures and existing tools also present ergonomic challenges, potentially leading to repetitive strain injuries when installing large irrigation systems with numerous connection points. The awkward hand positioning and excessive force required can cause discomfort or injury, particularly for professional installers who perform these tasks regularly.

Another significant issue with current methods is maintaining the sterility of the coupling during insertion, which is crucial for applications where water quality must be preserved, such as in agricultural settings where contaminants could affect crop health. There exists a need for a specialized tool that can simultaneously secure the tubing or pipe while precisely controlling the insertion of a drip coupling, reducing the physical effort required, minimizing the risk of component damage, improving insertion accuracy, accommodating various tubing materials and sizes, and enhancing the overall efficiency and safety of drip irrigation system installation and maintenance.

Therefore, there is a need for a tool that can facilitate the insertion of a drip coupling into tubing or pipe, accommodating varying diameters and types of tubing materials, and providing a secure grip and precise alignment for efficient and effective installation. Such a tool would significantly improve the process of setting up and maintaining drip irrigation systems, promoting better water efficiency and healthier landscapes.

### SUMMARY OF THE INVENTION

The present invention provides a plier apparatus specifically designed for facilitating the insertion of drip couplings into tubing or pipe. The present invention relates to a tube coupler plier designed to facilitate the insertion of drip couplings into tubing or pipe. The tube coupler plier comprises first and second elongated bodies pivotally connected at a fulcrum point, each having a head end and a handle end. A tube grip is located at the head end of the first elongated body, while a holder is integrated into the head end of the second elongated body. This design enables simultaneous manipulation of both the tube/pipe and the drip coupling through a single actuation motion

The holder is specifically sized to accommodate the coupling head of a drip coupling, allowing the coupling ridge and insertion point to extend from the bottom of the holder. When the handles are actuated toward each other, the bottom of the holder moves toward the tube grip, thereby inserting the drip coupling into the tubing or pipe. The tube grip is designed to accommodate various tube sizes ranging from about 0.125 inches to about 2 inches in diameter, while the holder can accommodate drip couplings from about 0.25 inches to about 0.75 inches.

The tube grip may feature fixed, adjustable, or self-adjusting jaws with various surface textures to enhance friction and prevent slippage. The plier apparatus can have a force-multiplying mechanism using opposing cams provides mechanical advantage during insertion, reducing required hand strength by at least 50%. The first and second handle can have anti-slip materials distribute pressure evenly across the user's hand. For challenging insertions, a ratcheting mechanism allows for incremental advancement, enabling users to rest between force applications.

The holder may include a recessed cavity with alignment guides to ensure proper positioning of the coupling. The plier may incorporate additional features such interchangeable holder inserts for different coupling sizes, alignment indicators, depth control mechanisms, and an integrated tubing cutter. The holder may also include a holder ridge configured to fit within a depressed portion of the coupling head.

The plier can have a coupling alignment indicator system using visual markings or mechanical guides, and a depth control mechanism prevents over-insertion. The plier apparatus can be constructed from corrosion-resistant materials with UV protection. In other embodiments, the plier apparatus can have an integrated tube cutting mechanism, allowing users to measure, cut, and connect tubing with a single tool, and a storage compartment within the handle for spare couplings. The plier apparatus is compatible with various tubing materials including PVC, polyethylene, and metal, making it versatile for different irrigation system installations and repairs.

A method for using the plier involves securing the tubing within the tube grip, placing the drip coupling in the holder, aligning the components, and applying pressure to the handles to advance the coupling into the tubing while maintaining a secure grip on the tubing.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 shows an iso-metric view of a plier apparatus in accordance to one or more embodiments;

FIG. 2 shows a font view of a plier apparatus in accordance to one or more embodiments;

FIG. 3 shows a top view of a plier apparatus in accordance to one or more embodiments;

FIG. 4shows a font view of a plier apparatus in accordance to one or more embodiments;

FIG. 5shows a back view of a plier apparatus in accordance to one or more embodiments; and

FIG. 6 shows a front view of a plier apparatus with drip coupling installed into tube in accordance to one or more embodiments

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. As used herein, the term ‘about’ when used in reference to a numerical value refers to a range that is within plus or minus ten percent (±10%) of the stated value. For example, ‘about 100’ encompasses values from 90 to 110, inclusive. It should be noted that there are many different and alternative configurations, devices, and technologies to which the disclosed inventions may be applied. The full scope of the inventions is not limited to the examples that are described below.

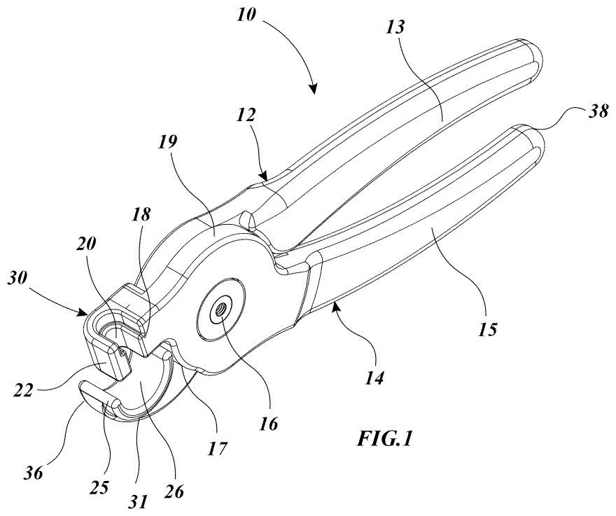

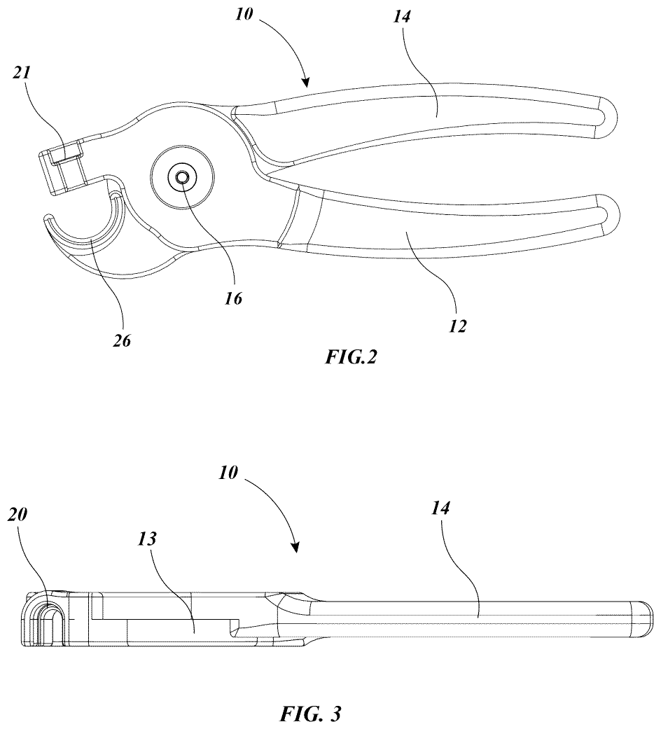

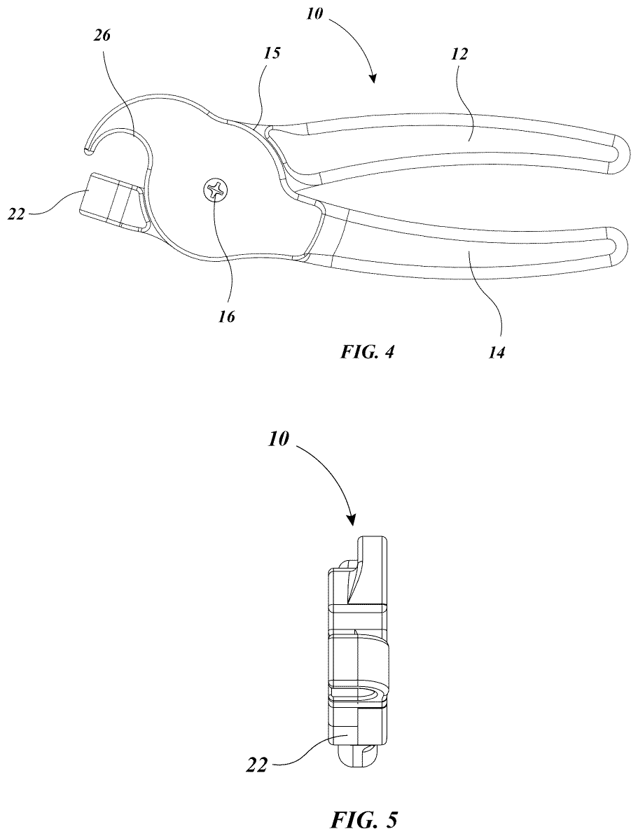

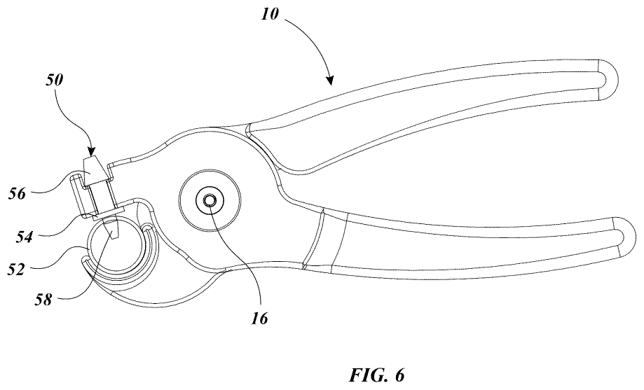

Referring to FIGS. 1-6, a tube coupler plier or plier apparatus 10 for facilitating the insertion of a drip coupling 50 having a coupling ridge 54, a coupling head 56, and an insertion point 58 into tubing or pipe 52. The tube coupler plier or plier apparatus 10 comprises a first elongated body 12 and a second elongated body 14 pivotally connected at a fulcrum point 16. Each elongated body has a head end 36 and a handle end 38. The first elongated body 12 can have a first handle 13 and the second elongated body 14 can have a second handle 15 at the handle end for manipulating the plier apparatus 10, while the plier can have the functional components for gripping tubing and holding drip couplings at the head end. The first elongated body 12 and the second elongated body 14 can be arranged in a scissor-like configuration, pivoting around a fulcrum point 16, which can be pivotally coupled by such as, for example, a bolt, a pin, or other suitable pivoting mechanism. The fulcrum point 16 can be positioned to provide a mechanical advantage when the first handle 13 and the second handle 15 are squeezed together. The coupling head 56 can have a depressed portion and wherein the holder can have a holder wall having a holder ridge 21 configured to fit within the depressed portion of the coupling head.

The first handle 13 and the second handle 15 can be ergonomically designed with contoured surfaces to fit comfortably in a user's hand. The first handle 13 and the second handle 15 can have a grip surface which can be integral to the handles or applied as separate components by such as, for example, rubber overlay, silicone grips, anodizing, overmolding, coated or the like. The grip surfaces can be made from anti-slip materials such as, for example, rubber, silicone, textured polymers, or the like and can be contoured to distribute pressure evenly across the user's hand during operation, reducing fatigue during extended use.

In embodiments, the tube grip 26 can be integrated into the head end 36 of the first elongated body 12. The tube grip 26 can securely hold a tube or pipe during the coupling insertion process. The tube grip 26 can accommodate either a tube or pipe with diameters ranging from such as, for example, at least 0.125 inches to at least 2 inches.

In certain embodiments, the tube grip 26 can be substantially u-shaped and can comprise a fixed jaw 25 with an inner surface that can be such as, for example, textured, smooth, grooved, knurled or the like which can enhance friction and prevent slippage during operation. The textured surface can have such as, for example, serrations, teeth, a specialized coating to improve grip, or the like while minimizing damage to the tubing material. In other embodiments, the tube grip 26 can comprise an adjustable jaw that can be manually configured to accommodate different tubing diameters, which can be adjusted but such as, for example, a sliding mechanism, a threaded adjuster, interchangeable jaw inserts, or the like. In another embodiment, the tube grip can comprise self-adjusting jaws that automatically conform to various tubing diameters without requiring manual adjustment. These self-adjusting jaws can utilize such as, for example, spring tension, cam surfaces, or other mechanical principles to automatically adapt to different tubing sizes while maintaining optimal gripping pressure.

In embodiments, the tube grip 26 can be compatible with various tubing materials commonly used in irrigation systems, such as, for example, PVC, polyethylene, metal, or the like. The surface treatment of the tube grip 32 is optimized to provide sufficient friction without causing damage to softer materials like polyethylene tubing. The tube grip 26 can be size and shaped to partially or fully surround the pipe or tube such as, for example, a semi-circle having a thickness.

In embodiments, the head end 36 of the second elongated body 14 can comprise a holder 30 sized to accommodate a drip coupling. The holder 30 can hold such as, for example, a 0.25″ to 0.75-inch diameter drip coupling. The holder 30 can be adjustable to hold other size drip tubing. The holder 30 for the drip coupling can comprise a recessed cavity 20 and a forward alignment guide 22 and aft alignment guide 18 wherein the drip coupling can be securely held and in the proper orientation for insertion into the tube or pipe. The holder 30 can be coupled to or integrate into the end of the first handle 12 past the pivot joint 16. The forward alignment guide 22 and aft alignment guide 18 can ensure accurate positioning of the coupling within the holder 30. In other embodiments, the forward alignment guide 22 and the aft alignment guide 18 can be adjustable to fit varying size drip coupling such as, for example, ⅛ inch, ¼ inch, ½ inch, ¾ inch, 1 inch or the like. The holder 30 can be integrated into the head end of the second elongated body, the holder having a holder bottom 31 facing the tube grip, the holder sized to accommodate the coupling head of the drip coupling such that the coupling ridge and the insertion point extend from the bottom of the holder. The actuating of the handle end of the first elongated body 12 toward the handle end 38 of the second elongated body 14 moves the bottom 31 of the holder toward the tube grip.

In other embodiments, the holder 30 can have interchangeable holder inserts to accommodate multiple drip coupling sizes, including ¼″, ½″, and ¾″ coupling diameters. The inserts can be quickly swapped to adapt the tool to different coupling sizes commonly used in drip irrigation systems. The holder 30 can be modular with interchangeable inserts that can accommodate multiple drip coupling sizes, including such as, for example, standard ¼″, ½″, and ¾″ coupling diameters commonly used across residential and commercial drip irrigation systems. The quick-release inserts can be manufactured from such as, for example, UV-resistant polymer, plastic, metal, composite or the like that can prevent coupling damage while ensuring a secure fit during operation. The quick-change mechanism can allow for tool-free swapping, enabling landscapers and irrigation technicians to transition between different system components without interrupting their workflow. Each insert can feature color-coding (i.e., blue for ¼″, green for ½″, and red for ¾″) for instant size identification even in low-light conditions.

In embodiments, the integration of the tube grip 26 and the holder 30 in the plier apparatus 10 can allow for simultaneous manipulation of the tube or pipe and the drip coupling which can simplify the process of inserting a drip coupling into a tube or pipe. The first handle 12, the second handle 14, the holder 30, and the tube grip 26 can be made from such as, for example, carbon steel, stainless steel, tool steel, allow steel, aluminum, titanium, plastic, ceramic, composite, or the like. The first handle 12 and the tube grip 26 can be made from one piece or multiple pieces and coupled together, and the second handle 14 and the holder 30 can made of one piece or multiple pieces and coupled together.

In embodiments, the plier apparatus 10 can have a force-multiplying mechanism 17, 19 that provides mechanical advantage during the insertion process wherein the force-multiplying mechanism can significantly reduce the required hand strength, making the tool accessible to users with limited hand strength or those who need to perform multiple installations. The force-multiplying mechanism comprises opposing cams 19 integrated within the elongated bodies 12 and 14 at or near the pivot joint 16. The cams 52 can optimize the force transfer from the handles 13, 15 to the functional components at the handle ends, providing a mechanical advantage that reduces the required hand strength by at least 30% to 80% compared to manual insertion methods. The cam profiles can provide progressive resistance that matches the typical insertion force profile needed when installing drip couplings. This progressive resistance helps prevent sudden slippage or over-insertion that could damage the tubing or coupling.

In other embodiments, the plier apparatus 10 can have a ratcheting mechanism 54 that can allow for incremental advancement of the drip coupling into the tubing or pipe which can be valuable when working with rigid tubing materials or larger diameter couplings that require significant insertion force. The ratcheting mechanism can comprises a toothed rack on at least one of the elongated body 12, 14 and at least one pawl on the opposing elongated body. The pawl can engage with the toothed rack to maintain position during the insertion process, allowing users to rest between applications of force without losing progress. The ratcheting mechanism can include a release lever that disengages the pawl from the toothed rack when the insertion is complete or if repositioning is needed. This release mechanism allows for quick reset of the tool for subsequent operations.

In certain embodiments, the plier apparatus 10 can have a coupling alignment indicator and a depth control mechanism which can be the recessed cavity 20 and the forward alignment guide 22 and the aft alignment guide 18 which can ensure proper alignment and prevent over-insertion of the coupling into the tubing or pipe. The coupling alignment indicator may include visual markings or mechanical guides that signal proper alignment between the coupling and tubing. The indicators can be color-coded or tactile to provide feedback to the user during the alignment process. The depth control mechanism can comprise an adjustable stop that limits the travel of the elongated bodies 12, 14 to prevent over-insertion of the coupling wherein the depth control mechanism ensures optimal connection integrity by maintaining the appropriate insertion depth for different coupling and tubing combinations. The depth control mechanism can be adjustable to accommodate different coupling designs and tubing specifications, allowing users to customize the insertion depth based on manufacturer recommendations or specific application requirements.

In certain embodiments, the plier apparatus 10 can have an integrated tubing cutting mechanism positioned within or adjacent to the handles 13, 15 wherein the cutting mechanism can enable the users to measure, cut, and connect tubing with a single tool, improving efficiency during installation. The tubing cutting mechanism can include a blade with a protective cover when not in use, and a cutting guide to ensure straight, clean cuts. The cutting mechanism is designed to accommodate the same range of tubing diameters as the tube grip 32.

A method for inserting a drip coupling into tubing or pipe using the plier apparatus 10 comprises securing the tubing or pipe within the tube grip 26 of the plier apparatus 10. The tubing is positioned perpendicular to the long axis of the tool, with sufficient length extending beyond the tube grip 26 to accommodate the coupling insertion. Placing the drip coupling into recessed cavity 20 of the plier apparatus 10. The coupling is oriented with its insertion end facing the secured tubing, properly seated within the recessed cavity 20 and aligned using the forward and aft alignment guides. Aligning the drip coupling with the tubing or pipe. The user positions the plier apparatus 10 so that the coupling is properly aligned with the end of the tubing, using the coupling alignment indicator system 62 if available. Applying pressure to the handles 13, 15 of the plier apparatus 10 to simultaneously advance the drip coupling into the tubing or pipe while maintaining a secure grip on the tubing or pipe. In certain embodiments, if the ratcheting mechanism is engaged, the user may apply pressure incrementally, resting between applications of force as needed. In embodiments, continuing the application of pressure until the depth control mechanism indicates that proper insertion depth has been achieved. Releasing the handles 13, 15 and removing the plier apparatus 10 from the now-connected tubing and coupling. If the ratcheting mechanism was engaged, the user first activates the release lever to disengage the mechanism. The pliers have an adjustable or self-adjusting jaw, the method can further comprise adjusting the jaw of the tube grip to fit the sizing of the tubing or pipe to be used. The plier can have interchangeable holder inserts the method can further comprise inserting a holder insert consistent with the size of the drip coupling to be inserted.

The plier apparatus of the present invention has wide industrial applicability in the fields of irrigation system installation, agricultural operations, landscaping, horticulture, and residential gardening. The tool is particularly valuable for professional landscapers and irrigation technicians who install multiple drip irrigation systems and require efficient, ergonomic tools that reduce physical strain during repetitive tasks. The invention also has applications in related fields where similar connection tasks are performed, such as low-pressure plumbing installations, automotive fluid systems, and small-diameter tubing applications in various industrial settings.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A tube coupler plier for facilitating the insertion of a drip coupling having a coupling ridge, a coupling head, and an insertion point into tubing or pipe, the tube coupler plier comprising:
a first elongated body and a second elongate body pivotally connected at a fulcrum point each have a head end and handle end;
a tube grip at the head end of the first elongated body; and
a holder integrated into the head end of the second elongated body, the holder having a holder bottom facing the tube grip, the holder sized to accommodate the coupling head of the drip coupling such that the coupling ridge and the insertion point extend from the bottom of the holder;
wherein actuating the handle end of the first elongated body toward the handle end of the second elongated body moves the bottom of the holder toward the tube grip.

2. The plier of claim 1, wherein the first elongated body has a first handle, and the second elongated body has a second handle on their handle end.

3. The plier of claim 1, wherein the tube grip is configured to securely hold a tube or pipe of about 0.125 inch to about 2-inch diameter.

4. The plier of claim 1, wherein the holder is sized to hold a drip coupling of about 0.25 inch to about 0.75-inch.

5. The plier of claim 3, wherein the tube grip is configured to accommodate different sizes of tubing or pipe.

6. The plier of claim 5, wherein the tube grip comprises either a fixed, adjustable jaw or self-adjusting jaw with or without teeth.

7. The plier of claim 1 wherein the tube grip and has at least one of a smooth surface, textured surface, or a coating to enhance friction and prevent slippage during operation.

8. The plier of claim 1, wherein the holder for the drip coupling comprises a recessed cavity and a forward and aft alignment guide to ensure accurate positioning of the coupling within the holder.

9. The plier of claim 1, wherein the tube grip is configured to be compatible with various types of tubing materials selected from the list including PVC, polyethylene, and metal.

10. The plier of claim 1, wherein the first elongated body and the second elongate body comprise a force-multiplying mechanism that provides mechanical advantage during insertion process wherein the force-multiplying mechanism are opposing cams integrated within the elongate bodies at or near the pivot joint.

11. The plier of claim 2, wherein the first handle and the second handle have a grip surface which is integral to or placed on the handles.

12. The plier of claim 1, further comprising a ratcheting mechanism that allows for incremental advancement of the drip coupling into the tubing or pipe, enabling users to rest between applications of force.

13. The plier of claim 1, further comprising interchangeable holder inserts to accommodate multiple drip coupling sizes, including ¼″, ½″, and ¾″ coupling diameters.

14. The plier of claim 1, further comprising a coupling alignment indicator system, including visual markings or mechanical guides that signal proper alignment between the coupling and tubing.

15. The plier of claim 1, further comprising a depth control mechanism that prevents over-insertion of the coupling into the tubing or pipe, ensuring optimal connection integrity.

16. The plier of claim 2, further comprising a tubing cutter integrated into the first handle and the second handle.

17. The plier of claim 1 wherein the coupling head has a depressed portion and wherein the holder has a holder wall having a holder ridge configured to fit within the depressed portion of the coupling head.

18. A method for inserting a drip coupling into tubing or pipe using the pliers of claim 1, comprising the steps of:
securing the tubing or pipe within the tube grip;
placing the drip coupling into the holder;
aligning the drip coupling with the tubing or pipe;
applying pressure to the handles of the pliers to simultaneously advance the insertion point into the tubing or pipe while maintaining a secure grip on the tubing or pipe.

19. The method of claim 18 wherein the pliers have an adjustable or self-adjusting jaw, the method further comprising adjusting the jaw of the tube grip to fit the sizing of the tubing or pipe to be used.

20. The method of claim 18 wherein the plier have interchangeable holder inserts, the method further comprising inserting a holder insert consistent with the size of the drip coupling to be inserted.
